(19) United States
(12) Patent Application Publication
(10) Pub. No.: US 2026/0099427 A1
(43) Pub. Date: Apr. 9, 2026

(54) AUTOMATED ERROR TRACE ENHANCEMENT

(71) Applicant: Dell Products L.P., Round Rock, TX (US)

(72) Inventors: ChihHao HSU, Taichung City (TW); Yi-Ching WU, New Taipei City (TW); Darren CHANG, Kaohsiung City (TW)

(73) Assignee: Dell Products L.P., Round Rock, TX (US)

(21) Appl. No.: 18/905,766

(22) Filed: Oct. 3, 2024

(51) Int. Cl. G06F 11/36

(52) U.S. Cl. CPC G06F 11/364

(57) ABSTRACT

An information handling system may include at least one processor and a memory. The information handling system may be configured to: receive a request from a user to perform an operation; in response to an error occurring during performance of the operation and without additional user interaction, execute a tracing framework and retrying the operation within the tracing framework; and transmit trace data from the tracing framework to the user.

### TECHNICAL FIELD

The present disclosure relates in general to information handling systems, and more particularly to error tracing. This application is related to U.S. patent application Ser. No. 17/558,093, filed Dec. 21, 2021 (now U.S. Pat. No. 11,921,618, “the '618 patent”), which is incorporated by reference herein in its entirety.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Various errors may occur in the operation of an information handling system, due to programming bugs, input errors, hardware problems, etc. In the traditional approach to handling errors, error logs may be collected and passed along to customer service personnel for analysis. However, customer service personnel may lack visibility into the exact processes that are related to the error, making investigating the error akin to finding a needle in a haystack.

Embodiments of this disclosure implement a new framework for error tracing and investigation. When the error first occurs, an automatic trace framework is activated, and the process that failed is retried seamlessly. As discussed in more detail below, the automatic trace framework may provide customer service personnel with not just error logs, but also comprehensive error trace data, eliminating the need for customers to perform manual retries and significantly improving the efficiency of error analysis.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with error tracing may be reduced or eliminated.

In accordance with embodiments of the present disclosure, an information handling system may include at least one processor and a memory. The information handling system may be configured to: receive a request from a user to perform an operation; in response to an error occurring during performance of the operation and without additional user interaction, execute a tracing framework and retrying the operation within the tracing framework; and transmit trace data from the tracing framework to the user.

In accordance with these and other embodiments of the present disclosure, a method may include an information handling system receiving a request from a user to perform an operation; in response to an error occurring during performance of the operation and without additional user interaction, the information handling system executing a tracing framework and retrying the operation within the tracing framework; and the information handling system transmitting trace data from the tracing framework to the user.

In accordance with these and other embodiments of the present disclosure, an article of manufacture may include a non-transitory, computer-readable medium having computer-executable instructions thereon that are executable by an information handling system for: receiving a request from a user to perform an operation; in response to an error occurring during performance of the operation and without additional user interaction, executing a tracing framework and retrying the operation within the tracing framework; and transmitting trace data from the tracing framework to the user.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example architecture, in accordance with embodiments of the present disclosure; and

FIGS. 3-4 illustrate example methods, in accordance with embodiments of the present disclosure.

### DETAILED DESCRIPTION

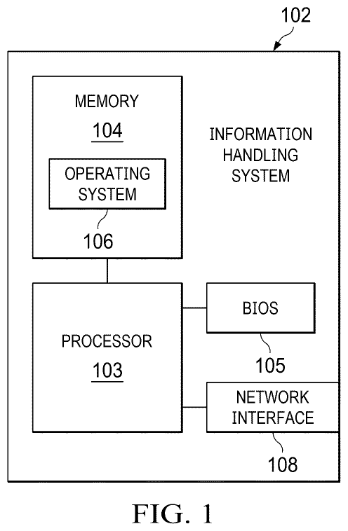

Preferred embodiments and their advantages are best understood by reference to FIGS. 1 through 4, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

During operation, information handling system 102 may encounter an error. For example, user may attempt to perform some action with information handling system 102, and that action may fail for some reason. As discussed above, embodiments of this disclosure provide a framework for analyzing such errors.

Embodiments may operate to record the operations of a process from the beginning of the problem. When an error arises, a trace framework may be activated, and the process may be automatically retried. For example, the process may be retried at the level of a single function call, multiple API interactions involving multiple nodes of a cluster (e.g., a hyperconverged infrastructure (HCI) cluster), or at an even higher level. The outcome of retrying the operation under the trace framework is a comprehensive record that includes both traditional log data and invaluable error tracing information. Additionally, the trace framework may then automatically disable itself after the retry process, in order to minimize the impact on system performance caused by the trace framework.

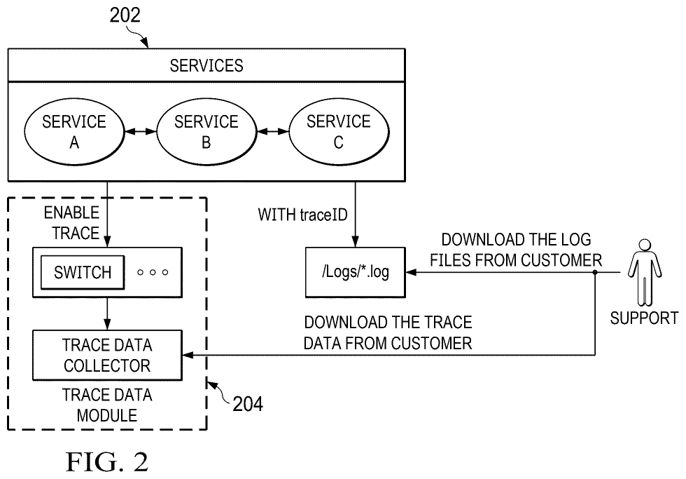

Turning now to FIG. 2, an example embodiment is shown for a platform operating on a microservices architecture, where numerous services 202 may interact with one another. This complex environment presents challenges when it comes to tracking and resolving errors, especially as they often transcend service boundaries. The '618 patent describes certain strategies for performing such tracing based on the use of a “span ID” and a “trace ID,” although other tracing schemes are also consistent with embodiments of this disclosure.

When an error occurs, the system may perform an automatic activation of trace data module 204. The trace framework may be as described in the '618 patent, or it may be any other desired framework. Subsequently, the process that generated the error is retried seamlessly. This eliminates the need for the user to perform a manual retry. A support agent may then gain access to both the error logs and the comprehensive trace data for thorough analysis. This integrated solution ensures a more efficient and user-friendly error resolution process.

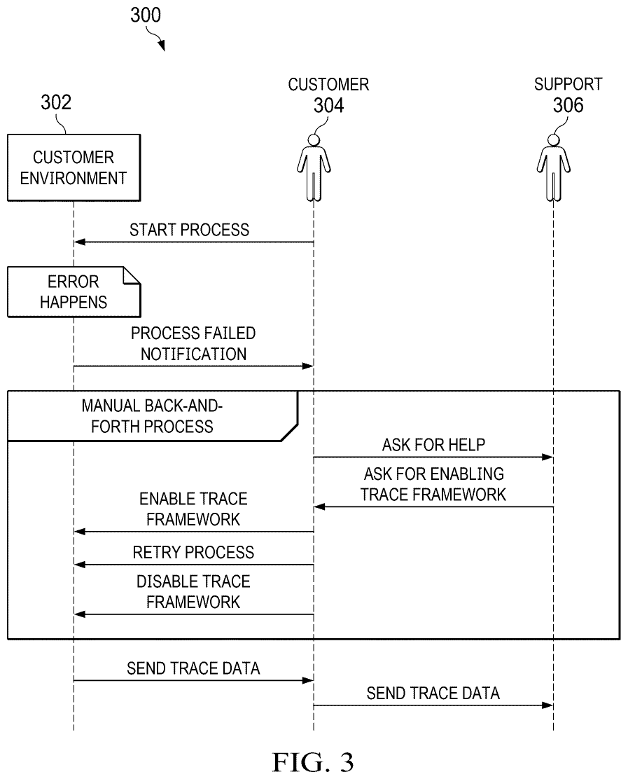

Turning now to FIG. 3, an example sequence diagram method 300 for error tracing is shown. In particular, FIG. 3 illustrates a method including a manual back-and-forth process. Customer 304 begins a process using customer environment 302, which may include one or more information handling systems.

When an error occurs, customer 304 is notified. Customer 304 may then have to engage in a lengthy process of asking for help from support personnel 306, manually enabling a trace framework, manually retrying the processer, manually disabling the trace framework, and manually sending the trace data to support 306.

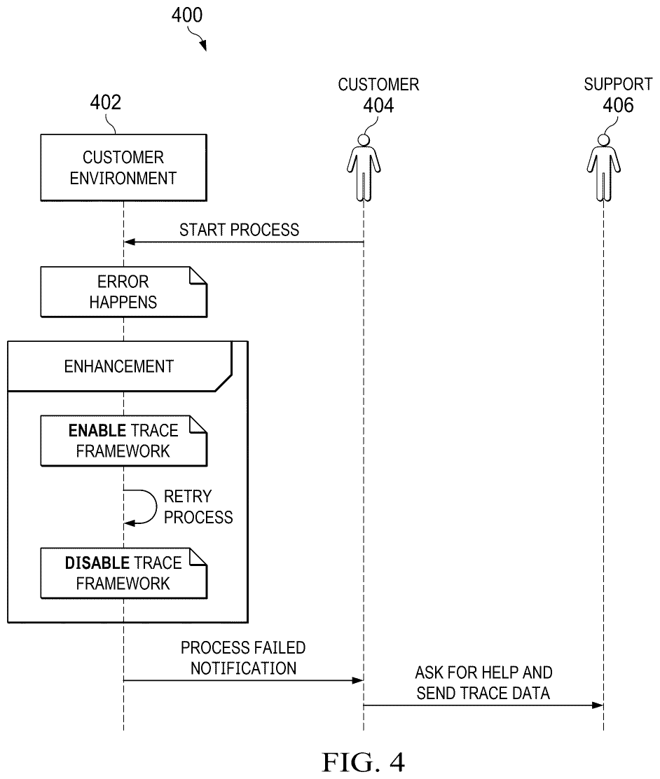

Turning now to FIG. 4, another example sequence diagram method 400 for error tracing is shown. In particular, FIG. 4 provides improvements relative to method 300. In particular, when the error occurs, no manual interaction from customer 404 is needed. The trace framework is enabled, and the process is retried automatically. By the time that customer 404 knows that anything has gone wrong, the trace framework has already collected all of the needed data from the retried process. And so only one interaction with support personnel 406 is needed, in which customer 404 asks for help and also provides the trace data.

One of ordinary skill in the art with the benefit of this disclosure will understand that the preferred initialization point for the methods depicted in FIGS. 3 and 4 and the order of the steps comprising those methods may depend on the implementation chosen. In these and other embodiments, these methods may be implemented as hardware, firmware, software, applications, functions, libraries, or other instructions. Further, although FIGS. 3 and 4 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. An information handling system comprising:
at least one processor; and
a memory;
wherein the information handling system is configured to:
receive a request from a user to perform an operation;
in response to an error occurring during performance of the operation and without additional user interaction, execute a tracing framework and retrying the operation within the tracing framework; and
transmit trace data from the tracing framework to the user.

2. The information handling system of claim 1, wherein the trace data further includes logging data.

3. The information handling system of claim 1, wherein retrying the operation comprises retrying a single function call.

4. The information handling system of claim 1, wherein retrying the operation comprises retrying a plurality of application programming interface (API) calls.

5. The information handling system of claim 4, wherein the plurality of API calls are retried on a plurality of nodes of an information handling system cluster.

6. The information handling system of claim 1, further configured to shut down the tracing framework after retrying the operation.

7. A method comprising:
an information handling system receiving a request from a user to perform an operation;
in response to an error occurring during performance of the operation and without additional user interaction, the information handling system executing a tracing framework and retrying the operation within the tracing framework; and
the information handling system transmitting trace data from the tracing framework to the user.

8. The method of claim 7, wherein the trace data further includes logging data.

9. The method of claim 7, wherein retrying the operation comprises retrying a single function call.

10. The method of claim 7, wherein retrying the operation comprises retrying a plurality of application programming interface (API) calls.

11. The method of claim 10, wherein the plurality of API calls are retried on a plurality of nodes of an information handling system cluster.

12. The method of claim 7, further comprising the information handling system shutting down the tracing framework after retrying the operation.

13. An article of manufacture comprising a non-transitory, computer-readable medium having computer-executable instructions thereon that are executable by an information handling system for:
receiving a request from a user to perform an operation;
in response to an error occurring during performance of the operation and without additional user interaction, executing a tracing framework and retrying the operation within the tracing framework; and
transmitting trace data from the tracing framework to the user.

14. The article of claim 13, wherein the trace data further includes logging data.

15. The article of claim 13, wherein retrying the operation comprises retrying a single function call.

16. The article of claim 13, wherein retrying the operation comprises retrying a plurality of application programming interface (API) calls.

17. The article of claim 16, wherein the plurality of API calls are retried on a plurality of nodes of an information handling system cluster.

18. The article of claim 13, wherein the instructions are further executable for shutting down the tracing framework after retrying the operation.
